(19) United States
(12) Patent Application Publication
(10) Pub. No.: US 2014/0253557 A1
(43) Pub. Date: Sep. 11, 2014

(54) USER-BASED MAP MANUFACTURING APPARATUS

(71) Applicant: DABEEO, INC., Seoul (KR)

(72) Inventor: Ju Hum PARK, Bucheon-si (KR)

(73) Assignee: DABEEO, INC., Seoul (KR)

(21) Appl. No.: 14/150,942

(22) Filed: Jan. 9, 2014

(30) Foreign Application Priority Data
Mar. 5, 2013 (KR) 10-2013-0023627

(51) Int. Cl. G06T 11/20

(52) U.S. Cl. CPC G06T 11/206
USPC 345/440

(57) ABSTRACT

A user-based map manufacturing apparatus includes an open street map (OSM) database (DB) configured to store OSM data, a map item DB configured to store a map item, and a map manufacturer configured to convert the OSM data into an OSM layer in an image format, and generate the map item in the OMS layer to manufacture a map.

### CROSS-REFERENCE TO RELATED APPLICATION

This application claims priority to and the benefit of Korean Patent Application No. 10-2013-0023627 filed in the Korean Intellectual Property Office on Mar. 5, 2013, the entire contents of which are incorporated herein by reference.

### BACKGROUND OF THE INVENTION

(a) Field of the Invention

The present invention relates to a user-based map manufacturing apparatus, and more particularly, to a user-based map manufacturing apparatus capable of manufacturing maps of various themes by selectively generating map items in an open street map (OSM) layer.

(b) Description of the Related Art

With the advancement of map-related technologies provided to electronic information terminals, various types of location-based services (LBSs) provided through maps have been developed.

A location-based service (LBS) includes point of interest (POI) information providing a phone number of a business enterprise and an address and detailed information of the business enterprise, information regarding a traffic situation, a road view of actual geographic features produced in panorama form so as to be displayed to users, a geographical information panorama such as aerial virtual reality (VR), and the like.

However, a related art map service provides the same type of map platform to every user, so each user cannot be provided with his or her desired type of map. In addition, the related art map service is only provided online so it is restricted in a communication environment, and the use of an online map service should be paid for.

As one of related arts, Korean Patent Laid-Open Publication No. 10-2005-0097618 (Oct. 10, 2005) discloses “System and method for manufacturing numerical map using GPS and INS”.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a user-based map manufacturing apparatus having advantages of manufacturing maps of various themes fitting user demand by selectively generating various map items in an open street map (OSM).

The present invention has also been made in an effort to provide a user-based map manufacturing apparatus having advantages of allowing a user to manufacture a map that meets his or her demand by himself or herself.

The present invention has also been made in an effort to provide a user-based map manufacturing apparatus having advantages of manufacturing maps of various themes and enhancing map efficiency, beyond a map transferred in a standardized manner.

The present invention has also been made in an effort to provide a user-based map manufacturing apparatus having advantages of providing a map service to a user even offline.

An exemplary embodiment of the present disclosure provides a user-based map manufacturing apparatus including: an open street map (OSM) database (DB) configured to store OSM data; a map item DB configured to store a map item; and a map manufacturer configured to convert the OSM data into an OSM layer in an image format, and generate the map item in the OMS layer to manufacture a map.

The map manufacturer may include: a road manager configured to draw a road from the map item DB to generate a road in the OSM layer; a theme information manager configured to draw theme information from the map item DB to generate the theme information in the OSM layer; and a rendering engine configured to render the OSM data to convert it into the OSM layer, and render the road and the theme information generated in the OSM layer by the road manager and the theme information managing, respectively, to generate the map.

The road manager may generate the road on the basis or latitude and longitude coordinates, or generate the road on the basis of virtual road data.

The theme information may include content representing a geographical environment of the real world and additional information with respect to the content.

The content may include an image representing a geographical environment of the real world.

The additional information may include any one or more of an image and text with respect to a geographical environment of the real world and address information of a Web page providing the geographical environment, and virtual reality (VR).

The theme information manager may generate the theme information on the basis of latitude and longitude coordinates in the OSM layer.

The map manufacturer may further include an application programming interface (API) configured to display the map on a manager terminal and allow the map to be edited in association with the manager terminal.

The map manufacturer may manufacture the map in a file format. Another embodiment of the present disclosure provides a user-based map manufacturing apparatus including: a display configured to display a map including generated map items in open street map (OSM) data; and an application programming interface (API) processor configured to receive the map from a map manufacturing module and display the map on the display.

The user-based map manufacturing apparatus may further include an input processor configured to input additional information, wherein the API processor may additionally generate the additional information input through the input processor in the map.

The additional information may include any one or more of a map item with respect to a geographical environment of the real world and a movement path of a user terminal.

The map item may include theme information, wherein the theme information may include content representing a geographical environment of the real world and additional information with respect to the content.

The additional information may include any one or more of an image and text with respect to a geographical environment of the real world and address information of a Web page providing the geographical environment, and virtual reality (VR).

The API processor may generate the movement path of the user terminal as a road in the map.

According to an exemplary embodiment of the present disclosure, various map items may be selectively generated in an open street map (OSM) according to themes such as society, culture, education, travel, medicine, traffic, and the like.

Also, according to an exemplary embodiment of the present disclosure, a user may be able to manufacture a map that meets his or her demand by himself or herself.

According to an exemplary embodiment of the present disclosure, maps of various themes such as society, culture, education, travel, medicine, traffic, and the like, beyond a map transferred in a standardized manner, may be manufactured.

According to an exemplary embodiment of the present disclosure, maps optimized by areas and themes may be provided, further enhancing map efficiency.

According to an exemplary embodiment of the present disclosure, since maps by areas and themes are transferred to a mobile terminal, a user may use a map service even offline.

### BRIEF DESCRIPTION OF THE DRAWINGS

FIG. 1 is a block diagram of a user-based map manufacturing apparatus according to an exemplary embodiment of the present disclosure.

FIG. 2 is a block diagram of a map manufacturing module of FIG. 1.

FIG. 3 is a conceptual view illustrating a process of manufacturing a map using a user-based map manufacturing apparatus according to an exemplary embodiment of the present disclosure.

FIG. 4 is a flowchart illustrating an operating process of the user-based map manufacturing apparatus according to an exemplary embodiment of the present disclosure.

FIG. 5 is a view illustrating an open street map (OSM) layer according to an exemplary embodiment of the present disclosure.

FIG. 6 is a view illustrating a map having roads and content generated in an OSM according to an exemplary embodiment of the present disclosure.

FIG. 7 is a view illustrating an example of content generated according to an exemplary embodiment of the present disclosure.

FIG. 8 is a view illustrating a map manufactured according to an exemplary embodiment of the present disclosure.

FIG. 9 is a view illustrating an example of an indoor map provided according to an exemplary embodiment of the present disclosure.

FIG. 10 is a block diagram of a user terminal according to an exemplary embodiment of the present disclosure.

### DETAILED DESCRIPTION OF THE EMBODIMENTS

Hereinafter, an apparatus for manufacturing a user-based map manufacturing apparatus according to an exemplary embodiment of the present disclosure will be described in detail with reference to the accompanying drawings. In the drawings, thicknesses of lines, dimensions of elements, and the like may be exaggerated for clarity and convenience. Also, terms described hereinafter are defined in consideration of functions in exemplary embodiments of the present disclosure and may be changed according to user/operator's intention or custom. Thus, definitions of terms should be defined on the basis of content throughout the specification.

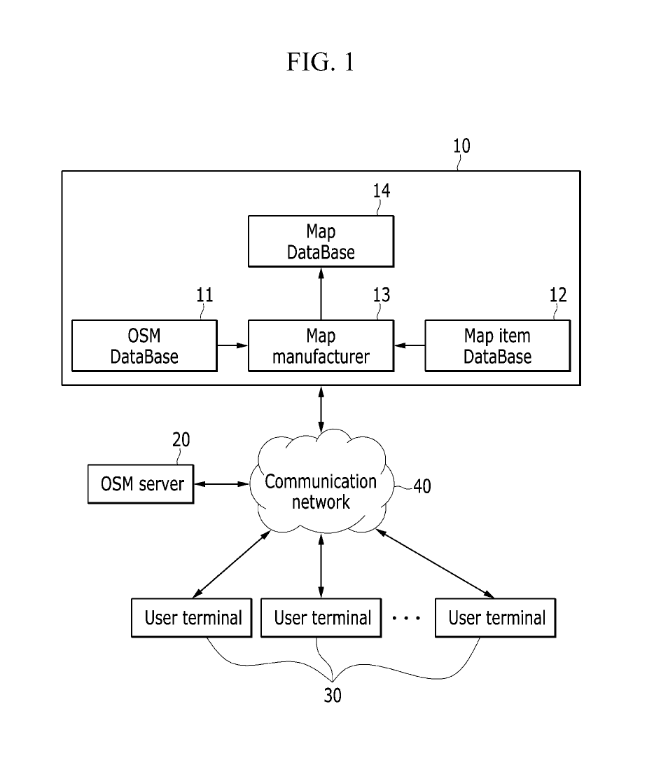

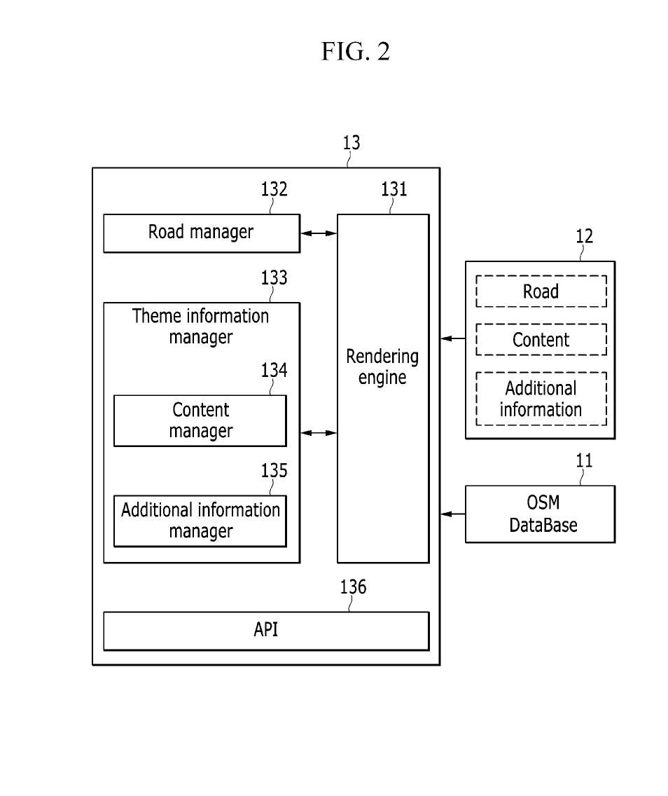

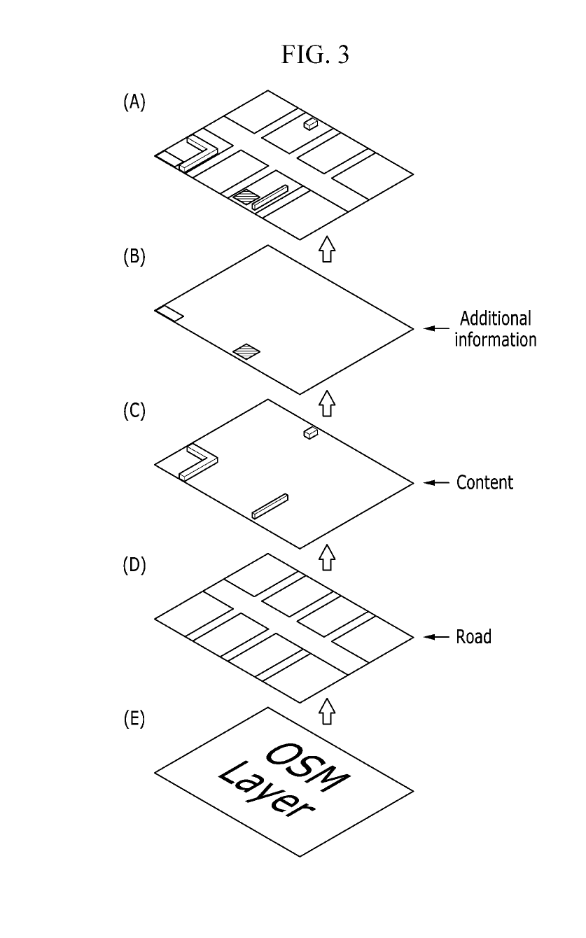

FIG. 1 is a block diagram of a user-based map manufacturing apparatus according to an exemplary embodiment of the present disclosure, FIG. 2 is a block diagram of a map manufacturing module of FIG. 1, and FIG. 3 is a conceptual view illustrating a process of manufacturing a map using a user-based map manufacturing apparatus according to an exemplary embodiment of the present disclosure.

Referring to FIG. 1, the user-based map manufacturing apparatus according to an exemplary embodiment of the present disclosure includes a map manufacturing module 10, an open street map (OSM) server 20, and a user terminal 30.

The OSM server 20 stores OSM data in a text format, and transfers the OSM data to the map manufacturing module 10 through a communication network 40.

The map manufacturing module 10 generates an OSM layer in an image format by using the OSM data in a text format, and generates map items according to a theme of the OSM layer to manufacture a map.

For reference, a theme may include society, culture, education, travel, medicine, traffic, and the like, as an object or field for using a map, and various types of information on the basis of each theme may be included as map items according to each theme.

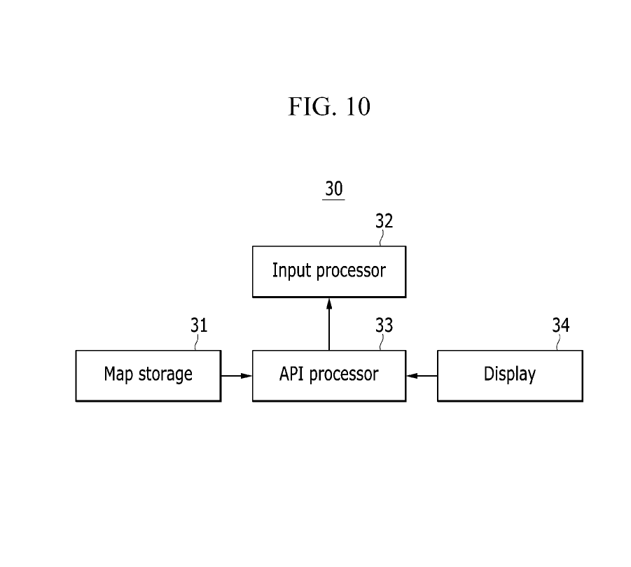

In addition, a user may select a map appropriate to a theme that he or she wants to use, and may directly edit the corresponding map by himself or herself. This will be described in detail with reference to FIG. 10.

Meanwhile, the map manufacturing module 10 includes an OSM database (DB) 11, a map item DB 12, a map DB 14, and a map manufacturer 13.

The OSM DB 11 stores the OSM data in a text format received from the OSM server 20.

The map item DB 12 stores map items by regions and themes.

The map items may include theme information regarding roads and a geographical environment of the real world on the basis of the roads, such as a building, a road, a coastline, and the like.

The theme information includes content representing a geographical environment of the real world, and the like, and additional information regarding content.

Content refers to a geographical environment, for example, a building, facility, and the like, which is transferred in an image format, and additional information includes address information of a Web page, virtual reality, and the like, providing an image, text, and information regarding a geographical environment.

The map manufacturer 13 manufactures a map in an image format by rendering the OSM data stored in a text format in the OSM DB 11 and the map item stored in the map item DB 12. In particular, since the map manufacturer 13 generates different theme information in the OSM data, it may manufacture different maps according to themes even in the same area, providing a map appropriate for a purpose to a user.

Referring to FIG. 2, the map manufacturer 13 includes a rendering engine 131, a road manager 132, a theme information manager 133, and an application programming interface (API) 136.

The rendering engine 131 converts the OSM data in a text format into an OSM layer in an image format, and generates a map imaged in a 2D or 3D format by rendering map items generated through the road manager 132, the theme information manager 133, and the API 136. The rendering engine 131 changes the generated map into templates and stores the same.

The road manager 132 generates roads on the OSM layer by using latitude and longitude coordinates on the basis of the real world, or by using virtual road data not using latitude and longitude coordinates. In this case, the road manager 132 may generate roads according to selected points on the OSM layer, register information regarding the generated roads, such as names of the roads, road types, road widths, and the like, connect and separate the roads by adjusting the points, and generate nodes between coordinates.

In addition, the road manager 132 generates the generated roads in a text format and stores the same in the map DB 14, and renders the road-generated map through the rendering engine 131 and provides the same to a manager.

Here, the manager may include a client, for example, an enterprise, a public organization, and the like, who wants to provide roads to users. The manager may directly participate in manufacturing a map through the API 136 by using a manager terminal (not shown) to manufacture a desired type map.

The theme information manager 13, which includes a content manager 134 and an additional information manager 135, generates theme information in the map according to the foregoing theme.

Theme information includes themes. That is, society, environment, culture, medicine, travel, education, traffic, and the like, so the theme information manager 133 generates theme information in the OSM layer having the roads generated therein according to each theme.

The contents manager 134 generates content in the map including the generated roads. The contents manager 134 stores contents as a resource file and loads the same to the OSM layer, and registers content to the OSM layer on the basis of latitude and longitude coordinates. Also, the content manager 134 designates a name of content or a view level, registers coordinates on the OSM layer, and edits a coordinate style. Further, when content is generated on the road, the theme information manager 133 stores the generated content in a text format in the map DB 14, renders the same through the rendering engine 131, and provides the same to the manager terminal.

The additional information manager 135 generates additional information with respect to content or a road on the map. In this case, the additional information manager 135 maps additional information on the basis of the latitude and longitude coordinates or content, and processes information displayed in the content. The additional information manager 135 registers any one or more of text with respect to content, an image, address information of a Web page providing information regarding content, and virtual reality to coordinates.

The API 135 provides various editing functions and information providing functions with respect to the map to the manager. The API 136 provides general functions required for manufacturing a map, such as a magnifying and reduction level control function with respect to the map, a function of displaying a point with respect to latitude and longitude coordinates and supporting a custom point, a function of drawing a line between coordinates and selecting a line color, a function of processing a smooth position movement, a function of processing a smooth map style, a function of supporting mapping of coordinate reference information, for example, mapping such as text, image, address information, VR, and the like, to content, a function of supporting changing of a map display style, a function of selecting a map information display level, a function of displaying a current location, and the like.

That is, as illustrated in FIG. 3, when the rendering engine 131 renders the OSM data and generates an OSM layer (a), the map manufacturer 13 generates roads, content, and additional information in the OSM layer (b, c, and d). In this process, the rendering engine 131 renders the roads, content, and additional information to generate a map, which has been imaged in a 2D or 3D format, in a file format (e), and transfers the same to the manager terminal (not shown) or the user terminal 30.

In this case, the manager may complement the map by editing the map through the API 136 or by generating additional information, and a user may complement the map by editing the map through the API processing 33 or by generating additional information.

In addition, after the manager terminal generates the map in a file format by area or theme through the map manufacturer 13 based on the theme information, the manager terminal may transfer the map to the user terminal 30.

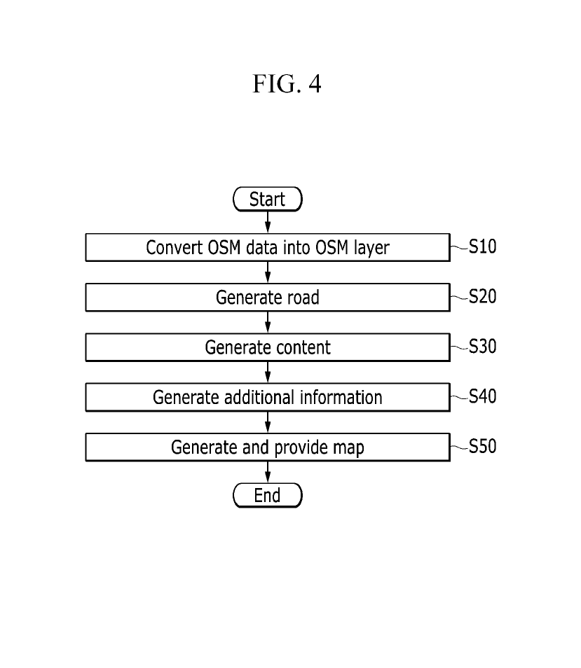

Hereinafter, a process of manufacturing a map by the map manufacturing module 10 according to an exemplary embodiment of the present disclosure will be described in detail with reference to FIGS. 4 through 9.

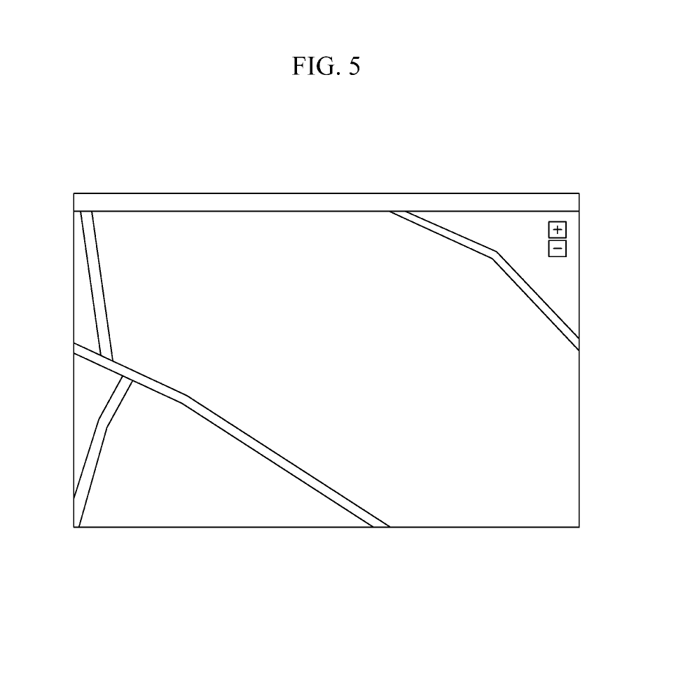

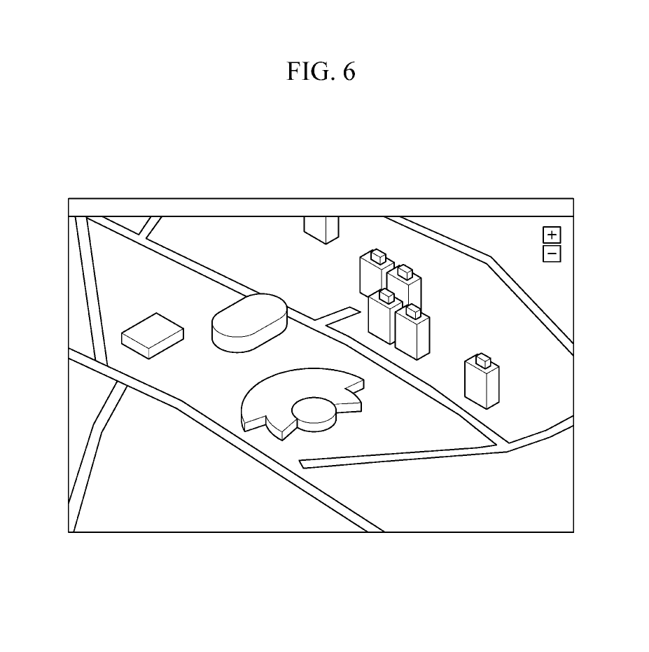

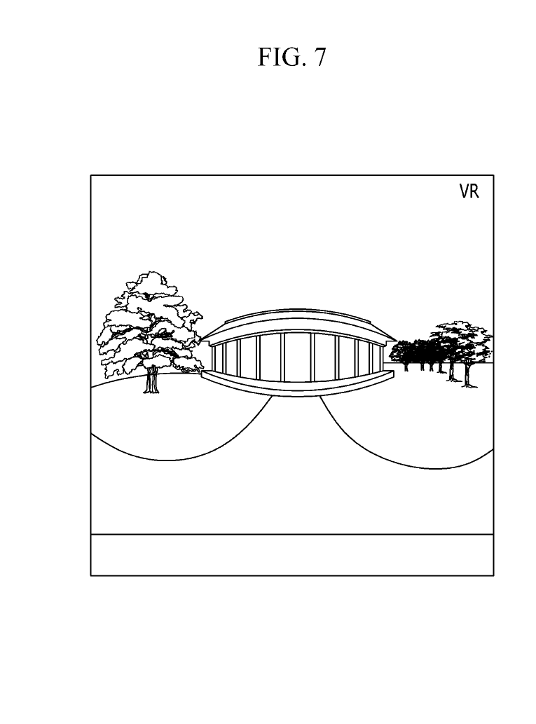

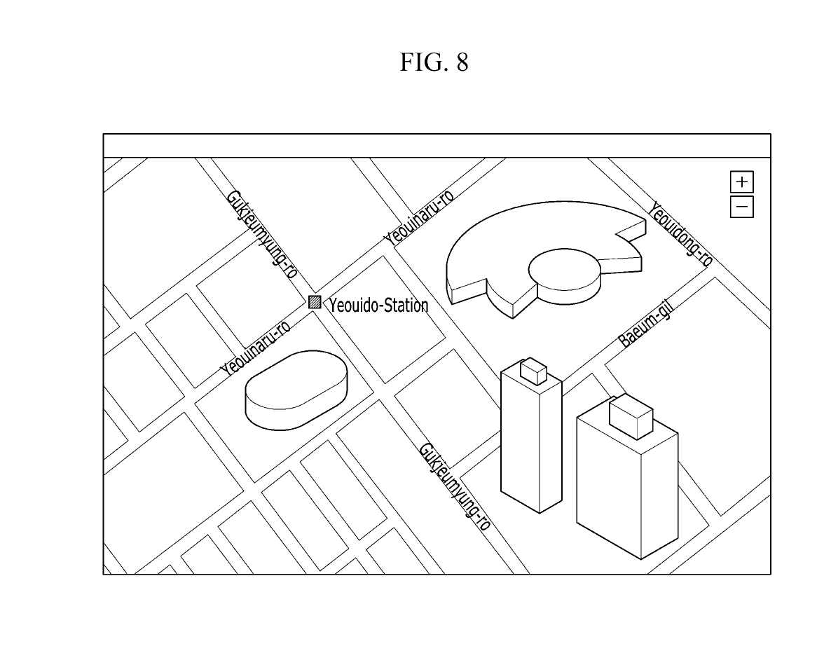

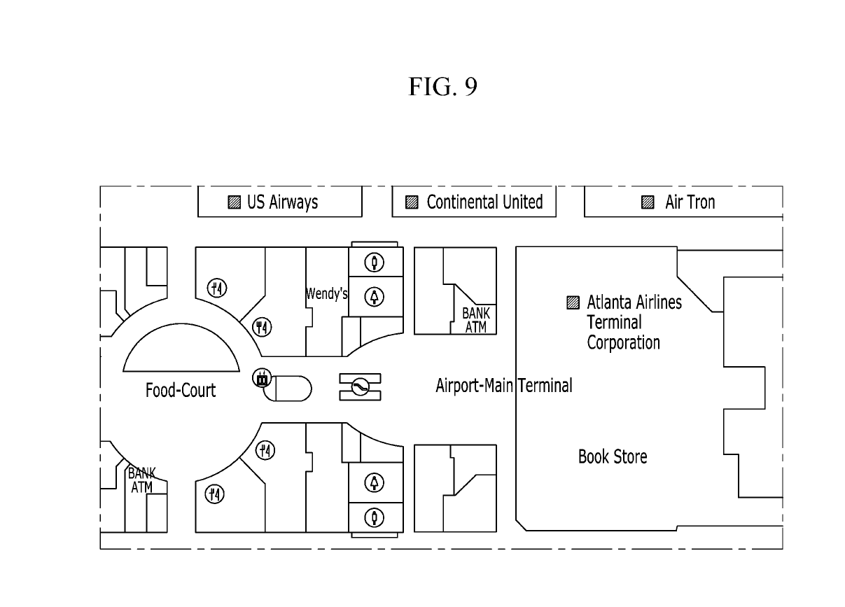

FIG. 4 is a flowchart illustrating an operating process of the user-based map manufacturing apparatus according to an exemplary embodiment of the present disclosure, FIG. 5 is a view illustrating an open street map (OSM) layer according to an exemplary embodiment of the present disclosure, FIG. 6 is a view illustrating a map having roads and content generated in an OSM according to an exemplary embodiment of the present disclosure, FIG. 7 is a view illustrating an example of content generated according to an exemplary embodiment of the present disclosure, FIG. 8 is a view illustrating a map manufactured according to an exemplary embodiment of the present disclosure, and FIG. 9 is a view illustrating an example of an indoor map provided according to an exemplary embodiment of the present disclosure.

Referring to FIG. 4, first, the map manufacturer 13 draws OSM data which has been transferred in a text format from the OSM server 20, from the OSM DB 11, and renders the same to convert the OSM data into an OSM layer as illustrated in FIG. 5 (S10).

After converting the OSM data into the OSM layer, the map manufacturer 13 draws map items required for generating a map from the map item DB 12 and produces them in the OSM layer.

That is, the map manufacturer 13 generates roads in the OSM layer according to road information drawn from the map item DB 12 (S20).

Also, as illustrated in FIG. 6, the map manufacturer 13 generates various content which has been drawn from the map item DB 12, in the OSM layer, including the generated roads on the basis of latitude and longitude coordinates (S30).

In addition, the map manufacturer 13 generates additional information in the OSM layer including generated content (S40). In this case, on the basis of the latitude coordinates, longitude coordinates, or content, the map manufacturer 13 maps additional information, for example, address information of a Web page providing text, image, and content, virtual reality, and the like, to the content. FIG. 7 illustrates an example of VR transferred in the additional information.

During this process, the rendering engine 131 renders a map item generated in the OSM layer to manufacture a map image in a 2D or 3D format, and the manager edits the map, content, and additional information generated in the OSM layer or additionally registers new information through the API 136.

Accordingly, the map manufacturer 13 finally generates a map according to editing and providing information through the API 136, stores the map in a text file format in the map DB 14, and transfers the same to the user terminal 30 that has requested the corresponding map (S50).

The map illustrated in FIG. 8 is manufactured by the map manufacturer 13, in which roads, names of the roads, road types, road widths, place names, and the like, are registered to the OSM layer, and for example, content related to an Expo is provided. That is, it can be seen that FIG. 8 is a map providing information related to an Expo.

In addition, the map manufacturing module 10 according to the present exemplary embodiment may be applied to an indoor map, as well as to the outdoor map as described above.

FIG. 9 illustrates an example of an indoor map, and the map manufacturing module 10 may generate map items in an OSM layer with respect to an indoor area to provide various map services in a large-scale building, a basement, and the like,

Generating map items in an OSM layer with respect to an indoor area to generate an indoor map is identical to the generating of the outdoor map as described above, so a detailed description thereof will be omitted.

Meanwhile, maps manufactured as described above are transferred to the user terminal 30. In this case, each map is transferred in a file format by area and theme, and the user may select a corresponding map according to a desired area or theme and download the same to the user terminal 30 before travel to even use the map service offline.

In addition, the user may directly edit the map through the user terminal 30 and use the same. This will be described with reference to FIG. 10.

FIG. 10 is a block diagram of the user terminal according to an exemplary embodiment of the present disclosure.

Referring to FIG. 10, the user terminal 30 according to the present exemplary embodiment includes a map storage 31, an input 32, an API processing 33, and a display 34.

Various display devices including a liquid crystal display (LCD) or a plasma display panel (PDP) may be employed as the display 34 and display a map.

The input 32 inputs various control commands of the user. The control commands include an ON/OFF command, a map display command, a map editing command, an additional information input command, and the like.

The map storage 31 stores a map transferred from the map manufacturing module 10 by area and theme according to a user request.

The API processing 33 draws a map from the map storage 31 according to a map display command and displays the same on the display 34, and edits the map according to a map editing command. For example, the API processing 33 provides general functions required for manufacturing a map, such as a magnifying and reduction level control function with respect to the map, a function of displaying a point with respect to latitude and longitude coordinates and supporting a custom point, a function of drawing a line between coordinates and selecting a line color, a function of processing a smooth position movement, a function of processing a smooth map style, a function of supporting mapping of coordinate reference information, for example, mapping such as text, image, address information, VR, and the like, to content, a function of supporting changing of a map display style, a function of selecting a map information display level, a function of displaying a current location, and the like.

In particular, the API processing 33 generates additional information on the map according to an additional information input command input through the input 32.

Such additional information includes the foregoing map items and a movement path of the user terminal 30, and as the map items are the same as described above, a detailed description thereof will be omitted.

The movement path of the user terminal is obtained through a global positioning system (GPS) receiver (not shown) provided in the user terminal 30, and this may be easily implemented by a person skilled in the art, so a detailed description thereof will be omitted.

Meanwhile, when the movement path of the user terminal 30 is input from the input 32, the API processing 33 recognizes the movement path of the user terminal as a road and generates the road on the map, thus newly updating the map. Further, the API processing 33 transfers the map to the map manufacturing module 10 through the communication network 40 such that roads may be generated in the corresponding map.

According to exemplary embodiments of the present disclosure configured as described above, various map items may be selectively generated in an OSM according to themes such as society, culture, education, travel, medicine, traffic, and the like, and a user may manufacture a map that meets his or her demand by himself or herself.

In addition, beyond a map transferred in a standardized manner, maps of various themes such as society, culture, education, travel, medicine, traffic, and the like, may be manufactured, further enhancing map efficiency.

In addition, according to exemplary embodiments of the present disclosure configured as described above, maps by areas and themes may be transferred to a mobile terminal, so a user may even use a map service offline.

The present invention has been described with reference to the embodiments illustrated in the drawings, but these are merely illustrative and those skilled in the art to which the present invention pertains may understand that various modifications and changes may be made from this description. Therefore, true technical coverage of the present invention should be determined by the appended claims.

### DESCRIPTION OF SYMBOLS

10: map manufacturing module

12: map item DB

11: OSM DB

13: map manufacturer

131: rendering engine

133: theme information manager

135: additional information manager

14: map DB

30: user terminal

32: input processor

34: display

132: road manager

134: content manager

136: API

20: OSM server

31: map storage

33: API processor

What is claimed is:

1. A user-based map manufacturing apparatus comprising:
an open street map (OSM) database (DB) configured to store OSM data;
a map item DB configured to store a map item; and
a map manufacturer configured to convert the OSM data into an OSM layer in an image format, and generate the map item in the OMS layer to manufacture the user-based map.

2. The user-based map manufacturing apparatus of claim 1, wherein the map manufacturer comprising:
a road manager configured to draw a road from the map item DB to generate the road in the OSM layer;
a theme information manager configured to draw theme information from the map item DB to generate the theme information in the OSM layer; and
a rendering engine configured to render the OSM data to convert it into the OSM layer, and render the road and the theme information generated in the OSM layer by the road manager and the theme information manager, respectively, to generate the user-based map.

3. The user-based map manufacturing apparatus of claim 2, wherein the road manager generates the road on the basis or latitude and longitude coordinates, or generates the road on the basis of virtual road data.

4. The user-based map manufacturing apparatus of claim 2, wherein the theme information comprises content representing a geographical environment of the real world and additional information with respect to the content.

5. The user-based map manufacturing apparatus of claim 4, wherein the content comprises at least an image representing the geographical environment of the real world.

6. The user-based map manufacturing apparatus of claim 4, wherein the additional information comprises any one or more of an image and text with respect to the geographical environment of the real world and address information of a Web page providing the geographical environment, and virtual reality (VR).

7. The user-based map manufacturing apparatus of claim 4, wherein the theme information manager generates the theme information on the basis of latitude and longitude coordinates in the OSM layer.

8. The user-based map manufacturing apparatus of claim 2, wherein the map manufacturer further comprises an application programming interface (API) configured to display the map on a manager terminal and allow the map to be edited in association with the manager terminal.

9. The user-based map manufacturing apparatus of claim 1, wherein the map manufacturer manufactures the user-based map in a file format.

10. A user-based map manufacturing apparatus comprising:
a display configured to display the user-based map including generated map items in open street map (OSM) data; and
an application programming interface (API) processor configured to receive the user-based map from a map manufacturing module and display the user-based map on the display.

11. The user-based map manufacturing apparatus of claim 10, further comprising:
an input processor configured to input additional information, wherein the API processor additionally generates the additional information input through the input processor in the map.

12. The user-based map manufacturing apparatus of claim 11, wherein the additional information comprises any one or more of a map item with respect to a geographical environment of the real world and a movement path of a user terminal.

13. The user-based map manufacturing apparatus of claim 12, wherein the map item comprises theme information, wherein the theme information comprises content representing the geographical environment of the real world and additional information with respect to the content.

14. The user-based map manufacturing apparatus of claim 13, wherein the additional information comprises any one or more of an image and text with respect to the geographical environment of the real world and address information of a Web page providing the geographical environment, and virtual reality (VR).

15. The user-based map manufacturing apparatus of claim 12, wherein the API processor generates the movement path of the user terminal as a road in the map.
